(19) United States
(12) Patent Application Publication
(10) Pub. No.: US 2006/0190952 A1
(43) Pub. Date: Aug. 24, 2006

(54) MAIN BODY OF AN OPTICAL DISK DRIVE CAPABLE OF PREVENTING AN OPTICAL PICK-UP HEAD AND A FLAT CABLE CONNECTED TO A MOTOR FROM BEING DAMAGED DURING AN ASSEMBLY PROCESS

(76) Inventor: Wen-Guang Hao, Su-Chou City, Chiang-Su Province (CN)

Correspondence Address: NORTH AMERICA INTELLECTUAL PROPERTY CORPORATION, P.O. BOX 506, MERRIFIELD, VA, 22116, US

(21) Appl. No.: 11/307,748

(22) Filed: Feb. 21, 2006

(30) Foreign Application Priority Data
Feb. 21, 2005 (TW) 094105079

(51) Int. Cl. G11B 33/12

(52) U.S. Cl. 720/652

(57) ABSTRACT

A main body of an optical disk drive includes a mounting plate, an optical pick-up head installed on a first side of the mounting plate in a slidable manner for reading or writing data in an optical disk, and a sled motor installed on the first side of the mounting plate. The top end of the sled motor on the first side of the mounting plate is protruding over a top end of the optical pick-up head. The main body further includes a support component installed on the first side of the mounting plate. The top end of the support component is protruding over the top end of the optical pick-up head. When the main body is placed on a work plane, the top ends of the sled motor and the support components are contacting the work plane.

### BACKGROUND OF THE INVENTION

1. Field of the Invention

The present invention relates to a main body of an optical disk drive, and more particularly, to a main body of an optical disk drive capable of preventing an optical pick-up head and a flat cable connected to a motor from being damaged during an assembly process.

2. Description of the Prior Art

In recent years, personal computers have changed from being calculation oriented to multimedia oriented. Therefore storage devices for storing a large amount of video information are improved continuously. An optical disk drive that can read and write information to an optical disk has become a mainstream product in the market. A pickup head of the optical disk drive emits laser beams with specific wavelengths and power to read information stored in the optical disk or write information into the optical disk. Specifically, the main products of optical disks are compact disks (CD) and digital versatile disks (DVD). The optical disks also can be divided into read-only optical disks, write-once optical disks, and rewritable optical disks. The optical disk drives can also be divided into video disk players and CD/DVD burners.

Please refer to FIG. 1. FIG. 1 is a schematic diagram of a main body 10 of an optical disk drive according to the prior art. The main body 10 includes a mounting plate 12, an optical pick-up head 14 installed on the mounting plate 12 in a slidable manner for reading or writing data in an optical disk, a spindle motor 16 installed on the mounting plate 12 for rotating the optical disk so that the optical pick-up head 14 can read or write data in the optical disk, and a spindle motor cable 18 connected to the spindle motor 16 for transmitting a signal to the spindle motor 16.

Please refer to FIG. 2. FIG. 2 is a schematic diagram of a reverse side of the main body 10 shown in FIG. 1 according to the prior art. The main body 10 further includes a sled motor 20 installed on the mounting plate 12 for driving the optical pick-up head 14 to slide on the mounting plate 12 back and forth.

Please refer to FIG. 3. FIG. 3 is a lateral view of the main body 10 positioning on a work plane 22 according to the prior art. The weight of the spindle motor 16 of the main body 10 generates a clockwise torque for the main body 10. The sled motor 20 protrudes from the mounting plate 12 at a certain height, so the main body 10 is inclined with respect to the work plane 22. This causes the optical pick-up head 14 to contact the work plane 22, and the inclination of the mounting plate 12 puts pressure on the spindle motor cable 18, eventually causing the spindle motor cable 18 to break.

The optical pick-up head 14 and the spindle motor 16 are two important components of the optical disk drive, and the cost of these two components contributes a big portion to the total cost of the optical disk drive. There is a need to prevent the damage of the optical pick-up head 14 and the spindle motor cable 18 due to the above-mentioned crush during the assembly process or the transportation process.

### SUMMARY OF THE INVENTION

It is therefore a primary objective of the claimed invention to provide a main body of an optical disk drive capable of preventing an optical pick-up head and a flat cable connected to a motor from being damaged during an assembly process for solving the above-mentioned problem.

According to the claimed invention, a main body of an optical disk drive includes a mounting plate, an optical pick-up head installed on a first side of the mounting plate in a slidable manner for reading or writing data in an optical disk, and a sled motor installed on the first side of the mounting plate. The top end of the sled motor on the first side of the mounting plate is protruding over a top end of the optical pick-up head. The main body further includes a support component installed on the first side of the mounting plate. The top end of the support component is protruding over the top end of the optical pick-up head. When the main body is placed on a work plane, the top ends of the sled motor and the support components are contacting the work plane so as to prevent the optical pick-up head from leaning against the work plane.

According to the claimed invention, a main body of an optical disk drive includes a mounting plate, a spindle motor for rotating an optical disk, a spindle motor cable connected to the spindle motor for transmitting a signal to the spindle motor, a sled motor installed on a first side of the mounting plate, and a support component installed on the first side of the mounting plate. When the main body of the optical disk drive is placed on a work plane, top ends of the support component and the sled motor are contacting with the work plane to prevent the mounting plate from slanting to press the spindle motor cable.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a main body of an optical disk drive according to the prior art.

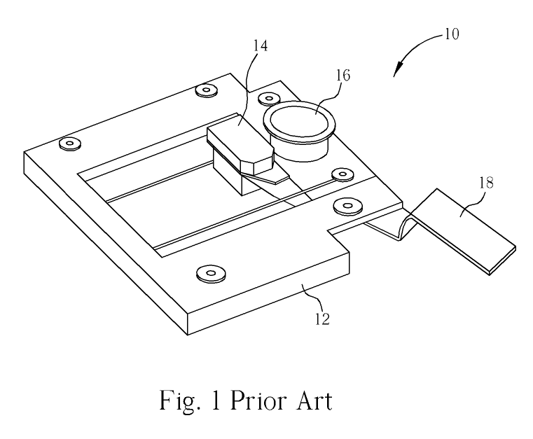

FIG. 2 is a schematic diagram of a reverse side of the main body shown in FIG. 1 according to the prior art.

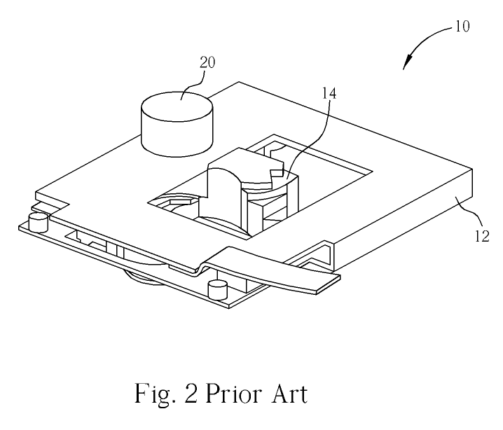

FIG. 3 is a lateral view of the main body positioning on a work plane according to the prior art.

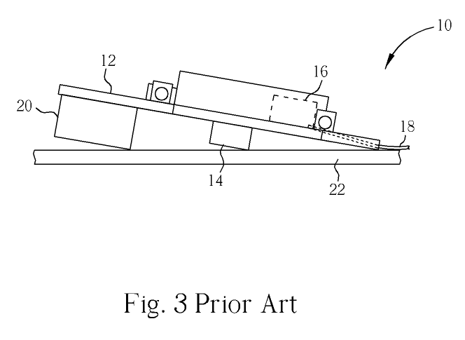

FIG. 4 is a schematic diagram of a main body of an optical disk drive according to the present invention.

FIG. 5 is a schematic diagram of a reverse side of the main body shown in FIG. 4 according to the present invention.

FIG. 6 is a lateral view of the main body positioning on a work plane according to the present invention.

### DETAILED DESCRIPTION

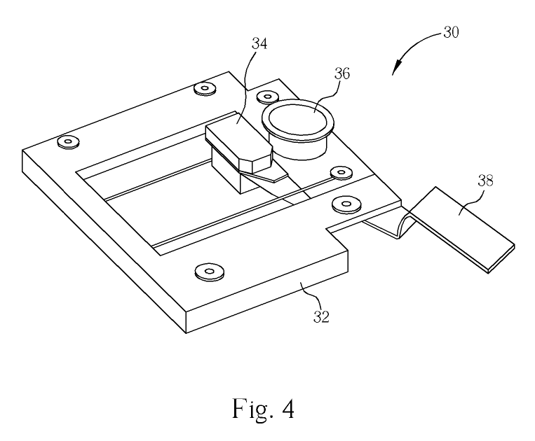

Please refer to FIG. 4. FIG. 4 is a schematic diagram of a main body 30 of an optical disk drive according to the present invention. The main body includes a mounting plate 32, an optical pick-up head 34 installed on the mounting plate 32 in a slidable manner for reading or writing data in an optical disk, a spindle motor 36 installed on a first side of the mounting plate 32 for rotating the optical disk so that the optical pick-up head 34 can read or write data in the optical disk, and a spindle motor cable 38 connected to the spindle motor 36 for transmitting a signal to the spindle motor 36.

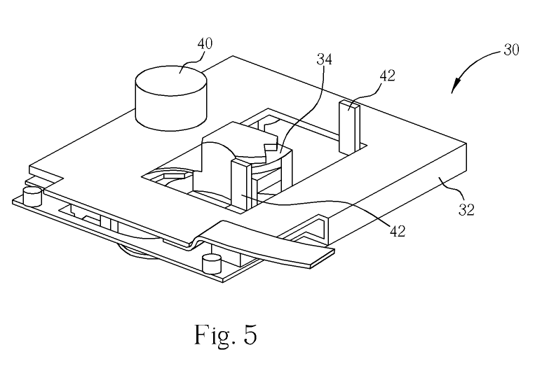

Please refer to FIG. 5. FIG. 5 is a schematic diagram of a reverse side of the main body 30 shown in FIG. 4 according to the present invention. The main body 30 further includes a sled motor 40 installed on a second side of the mounting plate 32 for driving the optical pick-up head 34 to slide on the mounting plate 32 back and forth. A top end of the sled motor 40 on the second side of the mounting plate 32 is protruding over a top end of the optical pick-up head 34 on the second side of the mounting plate 32. The main body 30 further includes two support components 42 in the substantially same height to the sled motor 40. The support components 42 are L-shaped holders individually protruding from the second side of the mounting plate 32. The support components 42 can be connected to the mounting plate 32 to create a monolithic structure, glued to the mounting plate 32, screwed to the mounting plate 32, wedged to the mounting plate 32, and so on. A top end of the support component 42 on the second side of the mounting plate 32 is protruding over the top end of the optical pick-up head 34 on the second side of the mounting plane 32. In addition, the height of the top end of the sled motor 40 on the second side of the mounting plate 32 is substantially equal to the height of the top end of the support component 42 on the second side of the mounting plate 32.

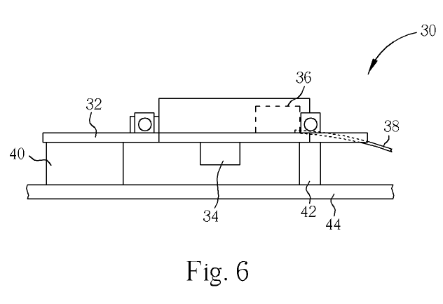

Please refer to FIG. 6. FIG. 6 is a lateral view of the main body 30 placing on a work plane 44 according to the present invention. As shown in FIG. 6, the top end of the sled motor 40 and the top end of the support component 42 contacts with the work plane 44. Because the height of the top end of the sled motor 40 on the second side of the mounting plate 32 is substantially equal to the height of the two top ends of the two support components 42 on the second side of the mounting plate 32, that is, the top ends of the sled motor 40 and the support components 42 are contacting the work plane 44 when the main body 30 is placed. The sled motor 40 and the two support components 42 can support the main body 30 above the work plane 44 together so as to prevent the optical pick-up head 34 from inclining to the work plane 44. In that way, the optical pick-up head 34 suspends above the work plane 44 instead of contacting with the work plane 44 so as to prevent the optical pick-up head 34 from colliding with the work plane 44 during the assembly process or the transportation process. In addition, the sled motor 40 and the support components 42 support the main body 30 above the work plane 44 together so as to prevent the mounting plate 32 from inclining to press the spindle motor cable 38.

In conclusion, the support components 42 are positioned between the mounting plate 32 and the work plane 42 so that the support components 42 and the sled motor 40 can support the main body 30 above the work plane 44 together for preventing the main body 30 from inclining during the assembly process and the transportation. The distance between the mounting plate 32 and the work plane 44 depends on the height of the top end of the sled motor 40 on the second side of the mounting plate 32 and the height of the top end of the support component 42 on the second side of the mounting plate 32. In addition, the number of the support components is not limited and depends on the stability of the main body 30 placed above the work plane 44.

In contrast to the conventional main body of the optical disk drive, the main body of the optical disk drive according to the present invention utilizes the support component and the sled motor for supporting the main body to be placed above the work plane stably. The present invention can prevent the main body of the optical disk drive from inclining to the work plane so that the optical pick-up head or the sled motor cable is damaged. The present invention can protect the key components of the main body of the optical disk drive during the assembly process or the transport process effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A main body of an optical disk drive comprising:
a mounting plate;
an optical pick-up head installed on a first side of the mounting plate in a slidable manner for reading or writing data in an optical disk;
a sled motor installed on the first side of the mounting plate, a top end of the sled motor on the first side of the mounting plate being protruding over a top end of the optical pick-up head; and
a support component installed on the first side of the mounting plate, a top end of the support component being protruding over the top end of the optical pick-up head,
wherein when the main body is placed on a work plane, the top ends of the sled motor and the support components are contacting the work plane.

2. The main body of claim 1 further comprising a spindle motor installed on a second side of the mounting plate for rotating the optical disk, and a spindle motor cable connected to the spindle motor, wherein the sled motor and the support component support the main body of the optical disk drive above the work plane together so as to prevent the mounting plate from inclining to press the spindle motor cable.

3. The main body of claim 1 wherein the height of the top end of the sled motor on the first side of the mounting plate is substantially equal to the height of the top end of the support component on the first side of the mounting plate.

4. The main body of claim 1 wherein the support component comprises two L-shaped holders.

5. The main body of claim 1 wherein the support component is connected to the mounting plate to create a monolithic structure.

6. The main body of claim 1 wherein the support component is glued to the mounting plate.

7. The main body of claim 1 wherein the support component is screwed to the mounting plate.

8. The main body of claim 1 wherein the support component is wedged to the mounting plate.

9. A main body of an optical disk drive comprising:
a mounting plate;
a spindle motor for rotating an optical disk;
a spindle motor cable connected to the spindle motor for transmitting a signal to the spindle motor;
a sled motor installed on a first side of the mounting plate; and
a support component installed on the first side of the mounting plate;
wherein when the main body of the optical disk drive is placed on a work plane, top ends of the support component and the sled motor are contacting with the work plane to prevent the mounting plate from inclining to press the spindle motor cable.

10. The main body of claim 9 further comprising an optical pick-up head installed on the mounting plate in a slidable manner for reading or writing data in the optical disk wherein the sled motor and the support component support the main body of the optical disk drive above the work plane together so as to prevent the optical pick-up head from inclining to the work plane.

11. The main body of claim 10 wherein the height of a top end of the sled motor on the first side of the mounting plate is greater than the height of a top end of the optical pick-up head on the first side of the mounting plate, and the height of a top end of the support component on the first side of the mounting plate is greater than the height of the top end of the optical pick-up head on the first side of the mounting plate.

12. The main body of claim 9 wherein the height of the top end of the sled motor is substantially equal to the height of the top end of the support component on the first side of the mounting plate.

13. The main body of claim 9 wherein the support component comprises two L-shaped holders.

14. The main body of claim 9 wherein the support component is connected to the mounting plate to create a monolithic structure.

15. The main body of claim 9 wherein the support component is glued to the mounting plate.

16. The main body of claim 9 wherein the support component is screwed to the mounting plate.

17. The main body of claim 9 wherein the support component is wedged to the mounting plate.
